(19) United States
(12) Patent Application Publication
(10) Pub. No.: US 2009/0296062 A1
(43) Pub. Date: Dec. 3, 2009

(54) METHOD OF MEASURING POSITION ERROR OF BEAM OF EXPOSURE APPARATUS AND EXPOSURE APPARATUS USING THE SAME

(76) Inventors: Sang-Hyun PARK, Yongin-si (KR); Sang-Don Jang, Ansan-si (KR); Hi-Kuk Lee, Yongin-si (KR); Jeong-Min Kim, Suwon-si (KR)

Correspondence Address: Haynes and Boone, LLP;IP Section, 2323 Victory Avenue, SUITE 700, Dallas, TX, 75219, US

(21) Appl. No.: 12/392,877

(22) Filed: Feb. 25, 2009

(30) Foreign Application Priority Data
May 29, 2008 (KR) 10-2008-0050236

(51) Int. Cl. G03B 27/54; G01B 9/02

(52) U.S. Cl. 355/67; 356/490

(57) ABSTRACT

A method of measuring a position error of a beam of an exposure apparatus and an exposure apparatus using the same are provided. An exposure apparatus using a digital micromirror device (DMD) element instead of a mask measures a radiation amount of a beam that passes through each pinhole using a mask including a pinhole, and when the radiation amount is less than a reference value, it is determined that an exposure beam has a position error. By using the exposure apparatus and a method of measuring a position error of a beam, a measurement time period is reduced, and a position error of a beam is simply and accurately determined.

### CROSS-REFERENCE TO RELATED APPLICATION

This application claims priority to and the benefit of Korean Patent Application No. 10-2008-0050236 filed in the Korean Intellectual Property Office on May 29, 2008, the entire contents of which are incorporated herein by reference.

### BACKGROUND OF THE INVENTION

(a) Field of the Invention

The present invention relates to a method of measuring a position error of a beam of an exposure apparatus, and an exposure apparatus using the same.

(b) Description of the Related Art

A liquid crystal display or a plasma display device performs a photolithography process in order to form a pixel and wiring. In general, in an exposure process of a photolithography process, a mask is used and an exposure beam is radiated through an opening of the mask.

However, masks should be individually formed in each pattern, and when a new pattern is formed, the mask should be newly formed. Because the manufacturing cost of the mask is high, when a new mask is formed, the process cost increases. In order to overcome such a drawback, an apparatus for exposing without using a mask has been developed.

However, even in a light exposer that does not use the mask, a process of correcting the light exposer is required, as in a light exposer that uses a mask. The correcting process indicates a series of processes of setting a reference coordinate of the apparatus in order to perform precision patterning and an overlay, and of defining all coordinates that have an influence on position accuracy such as a position of an actual exposure beam, a position of an alignment microscope, and a coordinate of a substrate, based on the reference coordinate.

Therefore, in order to correct a maskless light exposer, an amount by which an actual radiation position of a plurality of exposure beams that are radiated to a substrate through an optical modulation device and an optical system deviates from an ideal beam radiation position in a design aspect should be firstly measured.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of measuring a position error of a beam of an exposure apparatus and an exposure apparatus using the same having advantages of briefly measuring a position of a beam within a short time period in an exposure apparatus that does not use a mask.

The exposure apparatus has a mask having a plurality of pinholes that are larger than a diameter of an exposure beam and measures a light amount of the exposure beam passing through the mask using a sensor that is positioned at a rear surface thereof, thereby determining a position error of the exposure beam.

An exemplary embodiment of the present invention provides an exposure apparatus including: a light source; a digital micromirror device (DMD) element that modulates and transfers a beam that is provided from the light source and that includes a plurality of micromirrors that are arranged in a matrix; a mask that has a plurality of pinholes that are arranged in a matrix; and a sensor unit that is positioned at an opposite side of the DMD element based on the mask and that measures a radiation amount of a beam passing through the pinholes.

The pinholes may be a circle-shaped opening having a thickness of the mask.

The size of the pinholes may be greater than that of a region of an exposure beam that is radiated through one of the DMD elements.

Each of the micromirrors and the pinholes may be formed in the same quantity in a matrix structure.

The pinholes may be formed in a lesser quantity than that of the micromirrors.

The exposure apparatus may further include: a controller that controls the DMD element; an optical transmission means such as an optical fiber that transfers light from the light source to the DMD element and an optical path change means such as a reflector or a beam splitter; and an optical system that performs a function of concentrating focuses of beams that are selectively radiated from the DMD and of extending a distance between the beams.

The sensor unit may include a spherical sensor and a light collection means.

Another embodiment of the present invention provides a method of measuring a position error of a beam of an exposure apparatus, including: aligning masks having pinholes that are arranged in a matrix to correspond to exposure beams passing through an optical system and a DMD element consisting of a plurality of micromirror matrixes for modulating and transferring a beam that is provided from a light source; sequentially operating each micromirror of the DMD element; measuring a radiation amount of a beam passing through each pinhole and reaching a substrate using the sensor unit; and determining whether the DMD element uses a micromirror based on each measured radiation amount.

The determining of whether the DMD element uses the micromirror based on each measured radiation amount may include determining whether each radiation amount is greater than a reference radiation amount, and processing, if each radiation amount is less than a reference radiation amount, to not use the corresponding micromirror upon exposing.

The method may further include processing to not additionally use some micromirror having a radiation amount that is greater than a reference radiation amount in order to uniformly form an entire exposure amount after a micromirror that is processed to not be used is determined.

The determining of whether the DMD element uses the micromirror based on each measured radiation amount may include calculating a distance value between the center of an exposure beam that is transferred through each micromirror of the DMD element and the center of the pinhole based on the measured radiation amount, comparing the calculated distance value with a reference distance value, and processing, if the calculated distance value is greater than a reference distance value, to not use the corresponding micromirror upon exposing.

The method may further include processing to not additionally use some micromirrors having a lesser distance value than a reference distance value in order to uniformly form an entire exposure amount after a micromirror that is processed to not be used is determined.

The aligning of a mask may include matching the center of exposure beams that are transferred through each micromirror of the DMD element and that pass through the optical system and the center between the pinholes.

The aligning of a mask may include turning on specific beams around the DMD center that is known to have relatively little position error and performing alignment while minutely driving an alignment stage until the sum of a light amount in which the beams pass through the mask is maximized.

The aligning of a mask may include aligning the center of exposure beams that are transferred through each micromirror of the DMD element and that pass through the optical system and the center between the pinholes by intentionally imparting an offset by a predetermined distance.

The predetermined distance may be 1 μm or more.

The predetermined distance may be determined to distinguish a distance of 100 nm or more when a radiation amount difference of 5% occurs.

The sequentially operating each micromirror of the DMD element may include turning on/off the micromirrors one by one or operating the micromirrors based on units of a row, a column, or a region that is covered by a sensor.

A vector value of a position error as well as an absolute quantity of the position error may be detected by repeating the measurement process while minutely moving the aligned mask to a stage.

As described above, according to the present invention, because a position error of an exposure beam is determined using a radiation amount of an exposure beam that is radiated through a pinhole of the mask, it is unnecessary to move a mask. When a DMD passes on a measurement mark, as in an existing method (Japanese Patent Laid-Open Publication No. 2006-308997), because there is no drawback in which a very long repetition measurement time period is required as only a very few columns are measured according to a size of a sensor, a time period for detecting a position error of an exposure beam and a correcting time period of an experiment including the exposure beam are shortened. Thereby, an influence of an environment can be minimized and a laser can be more precisely measured. When using this method, because a position error of an exposure beam is simply and rapidly detected, a radiation amount can be constantly controlled upon exposing and a uniform exposure quality can be obtained.

### BRIEF DESCRIPTION OF THE DRAWINGS

FIG. 1 illustrates a configuration of an exposure apparatus according to an embodiment of the present invention.

FIG. 2 illustrates a DMD element of the exposure apparatus according to an embodiment of the present invention.

FIG. 3 illustrates an operation of the DMD element according to an embodiment of the present invention.

FIG. 4 illustrates a mask and a sensor board for measuring a position error of an exposure beam according to an embodiment of the present invention.

FIGS. 5 and 6 illustrate a mask for measuring a position error of an exposure beam according to an embodiment of the present invention.

FIG. 7 is a graph illustrating a profile (distribution) degree of a light amount of each beam according to an embodiment of the present invention.

FIGS. 8A and 8B are flowcharts illustrating a method of measuring a position error of an exposure apparatus according to an embodiment of the present invention.

FIG. 9 is a graph illustrating discrimination of a radiation amount according to an offset from a beam center that is used for aligning a mask according to an embodiment of the present invention.

FIG. 10 illustrates a structure of a sensor unit according to another embodiment of the present invention.

### DETAILED DESCRIPTION OF THE EMBODIMENTS

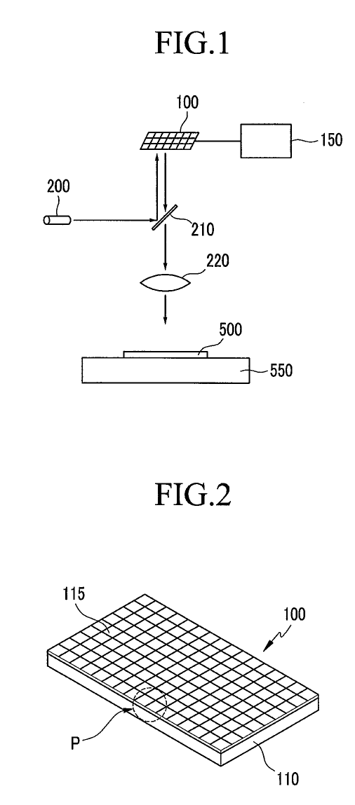

An exposure apparatus according to an embodiment of the present invention is described with reference to FIGS. 1 to 3.

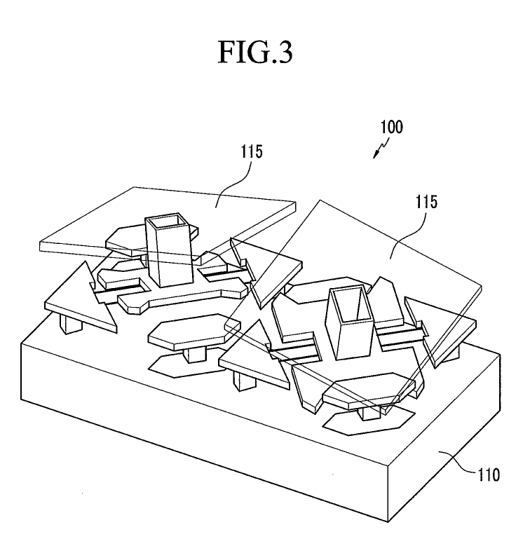

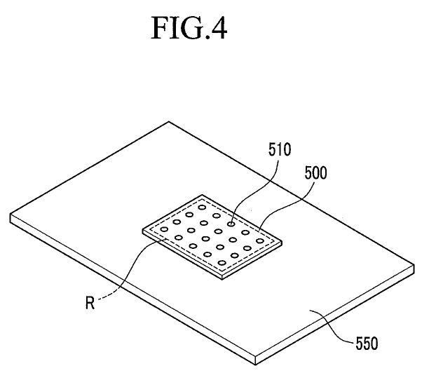

FIG. 1 illustrates a configuration of an exposure apparatus according to an embodiment of the present invention, FIG. 2 illustrates a DMD element of the exposure apparatus according to an embodiment of the present invention, and FIG. 3 illustrates an operation of the DMD element according to an embodiment of the present invention.

The exposure apparatus according to an embodiment of the present invention uses a DMD element 100 instead of a mask. Specifically, the exposure apparatus includes the DMD element 100, a controller 150, a light source 200, a beam splitter 210, an optical system 220, a mask 500, and a sensor unit 550. Although not all shown in the drawings, the exposure apparatus may include a device for correcting a focus of an exposure beam, a substrate 110 to which an exposure beam is radiated, a stage for transporting the substrate, a stage controller for controlling the stage, and a plurality of alignment microscopes for detecting a mark of the substrate. Further, the exposure apparatus further includes a light transmission means and a reflector such as an optical fiber for transferring light from the light source 200 to the DMD element 100, and may include an optical path change means such as the beam splitter 210.

As shown in FIGS. 2 and 3, the DMD element 100 includes a plurality of movable micromirrors 115 on the substrate 110. Each of the micromirrors 115 selectively reflects a beam that is provided from the light source 200 and transfers the beam to the substrate 110. As shown in FIG. 3, the micromirrors 115 may have an inclination angle of about 12° from the substrate 110 in one example. The DMD element 100 includes micromirrors 115 in a 1024×768 matrix form, and may have various other quantities.

FIG. 3 illustrates an operation of the micromirror of the DMD element.

Operation and control of the DMD element 100 are performed by the controller 150, and the controller 150 receives pattern information that is provided from the outside and controls the DMD element 100 to reflect an incident beam and to transfer the beam to an exposure region using the pattern information. Further, the controller 150 may control other units of the light source 200 and the exposure apparatus.

The light source 200 is a device for providing a beam that is used for exposure, and the beam splitter 210 transfers a beam that is provided from the light source 200 to the DMD element 100 and transfers a beam that is reflected from the DMD element 100 to the substrate. The optical system 220 may include a lens barrel consisting of a plurality of lens and has a function of concentrating beam focuses and of extending a distance between beams.

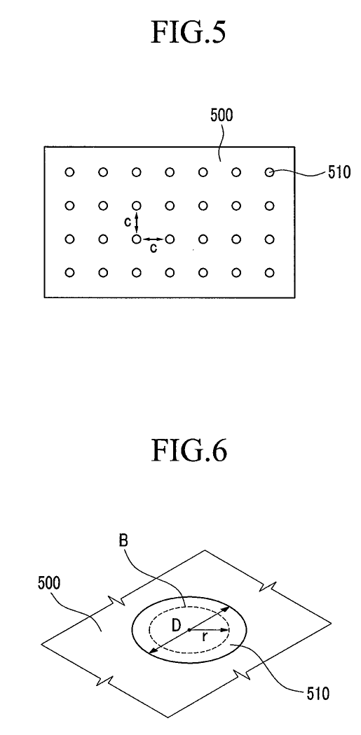

The mask 500 and the sensor unit 550 for detecting a position error of an exposure beam are described hereinafter in detail with reference to FIGS. 4 to 6.

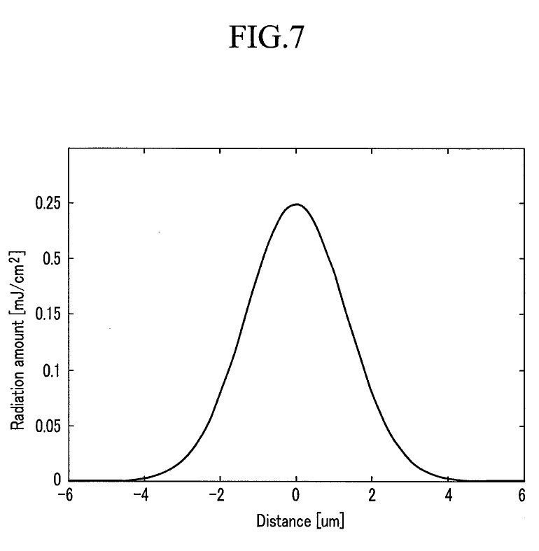

FIG. 4 illustrates a mask and a sensor board for measuring a position error of an exposure beam according to an embodiment of the present invention, and FIGS. 5 and 6 illustrate a mask for measuring a position error of an exposure beam according to an embodiment of the present invention.

The mask 500 includes pinholes 510 corresponding to each micromirror 115 of the DMD element 100. Each pinhole 510 is a circle-shaped opening having a thickness of the mask 500, and the structure and quantity of the pinholes 510 may be equal to or smaller than those of the micromirrors 115. That is, when the structure and the quantity of the pinholes 510 are equal to those of the micromirrors 115, because the pinholes 510 have a structure of 1024×768 like that of the micromirrors 115, all micromirrors 115 of the DMD element 100 can be inspected at one time. When the structure and the quantity of the pinholes 510 are smaller than those of the micromirrors 115, a sample inspection can be performed.

The pinholes 510 are disposed apart from each other by a predetermined space c, and in an embodiment of the present invention, the pinholes 510 are disposed apart from each other by a space of 60-70 μm (see FIG. 5).

Each pinhole 510 has a size that is greater than a size B (hereinafter referred to as an “exposure beam region”) of a beam that is radiated to the substrate in an exposure process. That is, when a radius of the exposure beam region B has a value r and the pinhole 510 has a value of a diameter D, the value D is greater than two times the value r (see FIG. 6). To form the pinhole 510 to be greater than the exposure beam region is to more accurately identify a position error of an exposure beam by improving discrimination, and has an advantage in identifying a vector position of the exposure beam. In an embodiment of the present invention, the pinhole 510 has a diameter of about 7 μm.

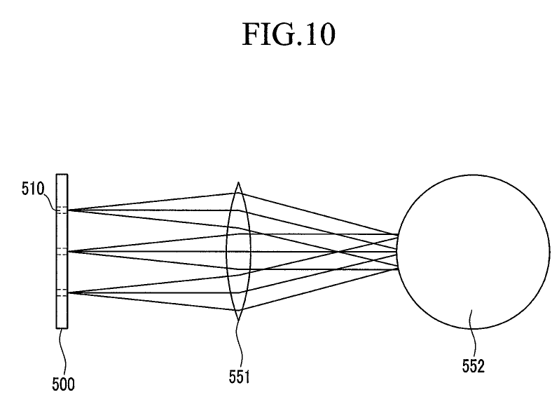

The sensor unit 550 is very greatly formed in a rear surface of the mask 500 so that a light amount passing through the pinhole 510 of the mask 500 may be detected in a predetermined sequence. The sensor unit 550 may be formed as a photo diode PD sensor or a spherical sensor that is shown in FIG. 10. The sensor unit 550 may be formed to measure each radiation amount that is input to a plurality of photo diodes PD and to simultaneously measure a radiation amount that is input to the photo diodes PD that are combined in units of a row or a column.

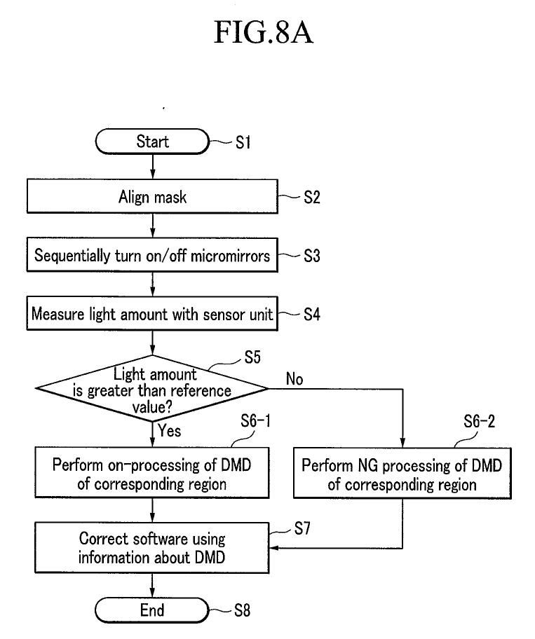

FIG. 7 shows a beam profile of a radius r direction of an exposure beam region B. The distribution thereof has a Gaussian form. The horizontal axis of FIG. 7 represents a distance from a beam center in the exposure beam region B, and the vertical axis thereof represents a radiation amount (mJ/cm²) per unit area. Because the exposure beam region B approximates a Gaussian distribution, when a radiation amount of a beam that passes through the mask 500 and that is measured by the sensor unit 550 substitutes for the graph, a deviation amount from the center of the pinhole 510 of a beam center according to a radiation amount of a beam can be calculated by a Gaussian integral equation.

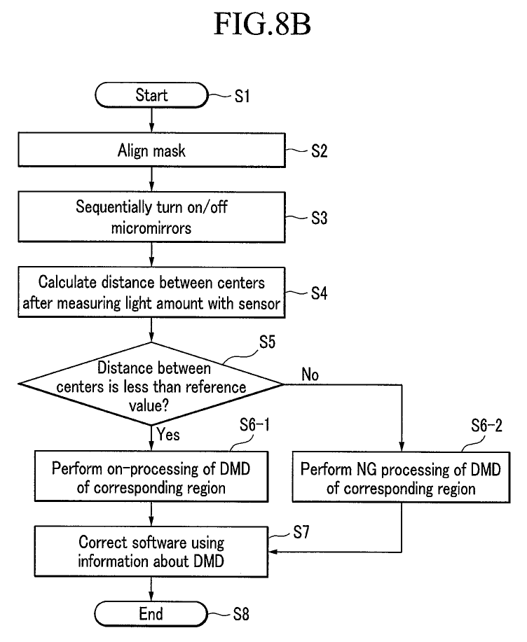

FIGS. 8A and 8B are flowcharts illustrating a method of measuring a position error of a beam of an exposure apparatus according to an embodiment of the present invention. FIG. 8A shows a method of measuring a position error of a beam based on a measured light amount, and FIG. 8B shows a method of measuring a position error of a beam based on a distance between centers.

First, the mask 500 and the sensor unit 550 are positioned on the stage and are precisely aligned to correspond to a radiation region on the substrate of a beam passing through the DMD element 100 and the optical system 220 (S2). The masks 500 are aligned so that the pinholes 510 may correspond to each of exposure beams, and in this case, the masks 500 may be aligned so that the center of the exposure beam region B may correspond to the center of the pinhole 510 or the masks 500 may be aligned by intentionally imparting a predetermined offset.

After an alignment step, by sequentially turning on/off each micromirror of the DMD element 100, the exposure beam is transferred to the stage (S3). When the micromirror is turned on, a beam form the light source is transmitted to the mask and sensor unit (e.g., mask 500 and sensor unit 550, as shown in FIG. 1). When the micromirror is turned off, a beam is not transmitted to the mask and the sensor unit. In an embodiment of the present invention, an on/off speed (frame rate) of the DMD element 100 is set to 10 KHz, but may be variously changed. The transferred exposure beam passes through each pinhole 510 and is detected by the photo diode PD of the sensor unit 550, and a light amount thereof is measured (S4).

By comparing the measured light amount with a preset reference light amount (FIG. 8A) or by comparing a calculated distance value between beam centers with a distance value between preset reference centers (FIG. 8B) (S5), NG processing of a beam is determined. That is, if a radiation amount that is measured by the sensor exceeds a preset reference radiation amount or if a distance value between beam centers is smaller than a distance value between preset reference centers, a micromirror of the corresponding DMD element 100 is continuously used (S6-1), and in an opposite case, the micromirror is processed (hereinafter referred to as “NG processing”) so that a beam is not transferred (S6-2).

When the sensor unit 550 has a structure for measuring a radiation amount in each pinhole 510, upon measuring a radiation amount, the sensor unit 550 determines an error by comparing a radiation amount that is measured in each pinhole 510 with a reference value. Alternatively, when the sensor unit 550 has a structure for measuring a radiation amount in units of a row or a column, an additional calculation step is required and the number of measurements of a radiation amount should also be increased. That is, in this case, as many result values of radiation amounts as the total quantity of the pinholes 510 are required, and by calculating the result values of radiation amounts using an equation, radiation amounts in each pinhole 510 are identified. Such a method is effective when it is difficult to measure with a photo diode PD because a radiation amount passing through each pinhole 510 is small and can reduce the cost of the sensor unit 550.

The controller 150 performs software correction (S7) by reflecting the NG-processed micromirrors, and performs an exposure process. In order to uniformly form an exposure amount on the substrate when performing the software correction, in addition to a micromirror in which the NG processing is performed, NG processing of some mirrors can be additionally performed.

That is, when an exposure is performed using the DMD element 100, an optical head consisting of the DMD element 100 and the optical system 220 is provided in a state that is rotated about the Z axis with a minute angle and the entire substrate is exposed while the stage moves under the optical head, and in this case, an exposure result is obtained by overlapping of beams. That is, when the stage is stopped or when the optical head is not rotated, a portion in which an exposure is not performed may exist, however when the stage moves and when an optical head that is rotated to a specific angle is used, exposure regions are overlapped due to a plurality of exposures and thus an omitted portion does not exist. However, due to a micromirror in which the NG processing is performed, the exposure amount may be insufficient at a predetermined position. In order to correct this, by additionally performing NG processing of other micromirrors, the entire exposure amount can be uniformly corrected. When the exposure amount is entirely reduced due to NG processing of an additional micromirror, by increasing intensity of a beam in the light source 200 or by reducing a moving speed of the stage upon exposing, the exposure amount can be adjusted.

Alignment of the mask 500 is described hereinafter in detail. In FIGS. 8A and 8B, it is explained that the masks 500 are aligned so that the center of the exposure beam region B corresponds to the center of the pinhole 510 or the masks 500 are aligned by intentionally giving a predetermined offset, and a reference of determining alignment and merits and drawbacks thereof are described.

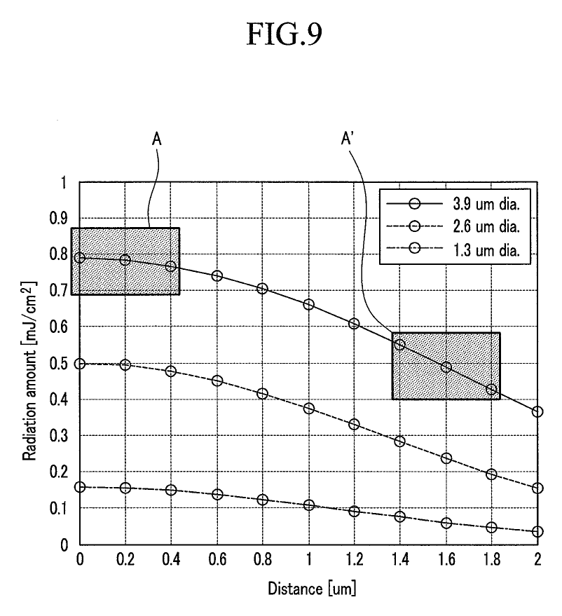

FIG. 9 shows a simulation graph of the change of a radiation amount according to a distance between two centers that are used for aligning a mask according to an embodiment of the present invention.

In FIG. 9, a beam having a total of 3 diameters is used, and a beam having a diameter of 3.9 μm among them is described.

The horizontal axis of FIG. 9 represents a distance from the center of the pinhole 510 to the center of an exposure beam region B, and the vertical axis thereof represents the change of a radiation amount according to the change of the distance.

In a region A of FIG. 9, when a distance between two centers is from 0 to 0.2 μm, the change of radiation amount according to the change of the distance is less. That is, in consideration of a measurement error and a radiation amount that is measured through the sensor unit 550, discrimination that can identify a correct distance between the two centers is very low.

In a region A′, as the difference of a radiation amount according to the change of a distance between the two centers increases, compared with the region A, discrimination of a distance value that is calculated based on the measured radiation amount significantly increases. This is because in a Gaussian distribution of a beam, as a distribution of a beam is deviated from the center, a gradient of the light amount rapidly changes. Therefore, by aligning the masks 500 apart by a predetermined distance (1 μm or more) than matching the center of the exposure beam region B and the center of the pinhole 510, discrimination and accuracy can be improved. In the present embodiment, when a radiation amount difference of 5% occurs, it is proposed to align the masks 500 with an offset of 1.6 μm that can distinguish 100 nm or more. To align the masks 500 apart by a predetermined distance may be performed in a process order of matching two centers and then moving the masks 500 by a predetermined distance.

In a method for matching two centers (i.e., aligning the masks 500 and an exposure region at a lower end of the exposure head), specific beams around a DMD center that is known to have relatively little position error are turned on and alignment is performed while minutely driving an alignment stage until the sum of light amounts in which the beams pass through the mask becomes the maximum.

As described above, when measuring an error using the mask 500 and the sensor unit 550, although a distance between the center of the exposure beam region B and the center of the pinhole 510 can be identified, a direction (vector) thereof cannot be identified. In order to identify a direction, a radiation amount is measured while moving the mask 500, and a Gaussian distribution equation is calculated based on a movement direction and a distance of the mask 500 and a measured radiation amount, whereby a vector direction of the exposure beam region B can be identified. When moving the mask 500, the X axis direction, the y axis direction that is perpendicular thereto, and a rotation direction θ are considered.

FIG. 10 illustrates a structure of a sensor unit according to another embodiment of the present invention.

By concentrating light that is transmitted through the pinhole 510 of the mask 500 to a light refraction means 551 and allowing the concentrated light to advance toward a spherical sensor 552, the spherical sensor 552 can measure the light amount. When light that is transmitted through the pinhole 510 passes through the light refraction means 551, light can be collected at a small region on the spherical sensor 552. In this case, an opening (not shown) may be formed in a light collection region so that light may enter into the spherical sensor 552 and be measured. When using this method, because all light amounts that are transmitted to the mask 500 can be measured using a sensor of a relatively smaller size than that of the mask 500, the total inspection of an beam position error can be quickly performed.

As described above, because a time period that is required in a method of simply and quickly measuring a position error of an exposure beam using the mask 500 and the sensor unit 550 depends on only a frame rate of the DMD element 100, there is an advantage that an actual measurement time period is significantly shortened, compared with an existing method. Because the measurement time period is short, the method is less sensitive to influence of the environment and thus measurement accuracy can be improved. Further, due to a decrease of a correcting (setting) time period of exposure equipment, the maintenance cost can be decreased and the equipment operation rate can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An exposure apparatus comprising:
a light source;
a digital micromirror device (DMD) element that modulates and transfers a beam that is provided from the light source and that comprises a plurality of micromirrors that are arranged in a matrix;
a mask that has a plurality of pinholes that are arranged in a matrix; and
a sensor unit that measures a radiation amount of a beam passing through the plurality of pinholes.

2. The exposure apparatus of claim 1, wherein the pinholes are circle-shaped openings having a thickness of the mask.

3. The exposure apparatus of claim 1, wherein a size of each of the pinholes is greater than a region of an exposure beam that is radiated from the DMD element.

4. The exposure apparatus of claim 1, wherein each of the micromirrors and the pinholes is formed in the same quantity in a matrix structure.

5. The exposure apparatus of claim 1, wherein the pinholes are formed in a lesser quantity than that of the micromirrors.

6. The exposure apparatus of claim 1, further comprising:
a controller that controls the DMD element;
an optical transmission means for transfering light from the light source to the DMD element;
an optical path change means; and
an optical system that concentrates focuses of beams passing through the DMD element and extends a distance between the beams.

7. The exposure apparatus of claim 1, wherein the sensor unit comprises a spherical sensor and a light collection means.

8. A method of measuring a position error of a beam of an exposure apparatus, the method comprising:
aligning masks having pinholes that are arranged in a matrix to correspond to exposure beams passing through an optical system and a digital micromirror device (DMD) element including a plurality of micromirror matrixes for modulating and transferring a beam that is provided from a light source;
sequentially operating each of the micromirrors of the DMD element;
measuring a radiation amount of a beam passing through each pinhole and reaching a substrate using a sensor unit; and
determining whether the DMD element uses a micromirror based on each measured radiation amount.

9. The method of claim 8, wherein the determining of whether the DMD element uses the micromirror based on each measured radiation amount comprises determining whether each radiation amount is greater than a reference radiation amount, and processing, if each radiation amount is less than a reference radiation amount, to not use the corresponding micromirror upon exposing.

10. The method of claim 9, further comprising processing to not additionally use some micromirror having a radiation amount that is greater than a reference radiation amount in order to uniformly form an entire exposure amount after a micromirror that is processed to not be used is determined.

11. The method of claim 8, wherein the determining of whether the DMD element uses the micromirror based on each measured radiation amount comprises calculating a distance value between the center of an exposure beam that is transferred through each micromirror of the DMD element and the center of the pinhole based on the measured radiation amount, comparing the calculated distance value with a reference distance value, and processing, if the calculated distance value is greater than a reference distance value, to not use the corresponding micromirror upon exposing.

12. The method of claim 11, further comprising processing to not additionally use some micromirrors having a lesser distance value than a reference distance value in order to uniformly form an entire exposure amount after a micromirror that is processed to not be used is determined.

13. The method of claim 8, wherein the aligning of a mask comprises matching the center of exposure beams that are transferred through each micromirror of the DMD element and that pass through the optical system and the center between the pinholes.

14. The method of claim 13, wherein the aligning of a mask comprises turning on specific beams around the DMD center that is known to have relatively little position error and performing alignment while minutely driving an alignment stage until the sum of a light amount in which the beams pass through the mask is maximized.

15. The method of claim 8, wherein the aligning of a mask comprises aligning the center of exposure beams that are transferred through each micromirror of the DMD element and that pass through the optical system and the center between the pinholes by intentionally imparting an offset by a predetermined distance.

16. The method of claim 15, wherein the predetermined distance is about 1 μm or more.

17. The method of claim 15, wherein the predetermined distance is determined to distinguish a distance of 100 nm or more when a radiation amount difference of 5% occurs.

18. The method of claim 8, wherein the sequentially operating each micromirror of the DMD element comprises turning on/off the micromirrors one by one or operating the micromirrors based on units of a row, a column, or a region that is covered by a sensor.

19. The method of claim 8, wherein a vector value of a position error and an absolute quantity of the position error is detected by repeating the measurement process while minutely moving the aligned mask to a stage.
